(19) United States
(12) Patent Application Publication
(10) Pub. No.: US 2009/0031616 A1
(43) Pub. Date: Feb. 5, 2009

(54) THERMOCHEMICAL METHOD FOR CONVERSION OF POULTRY LITTER

(76) Inventor: Foster A. AGBLEVOR, Christiansburg, VA (US)

Correspondence Address: BLANK ROME LLP, 600 NEW HAMPSHIRE AVENUE, N.W., WASHINGTON, DC, 20037, US

(21) Appl. No.: 12/184,814

(22) Filed: Aug. 1, 2008

Related U.S. Application Data
(60) Provisional application No. 60/953,341, filed on Aug. 1, 2007.

(51) Int. Cl. C10L 1/00; C05F 3/00

(52) U.S. Cl. 44/307; 71/21

(57) ABSTRACT

Methods for converting waste litter into a product slate by pyrolysis are described. Waste litter is entrained in a non-reactive gas and delivered to a fluid reactor bed maintained at a temperature sufficient to cause pyrolysis of the poultry litter. The reactor bed consists of a fluidizing medium, such as sand, which is fluidized by the non-reactive gas. Upon pyrolysis of the poultry litter, products such producer gas, biooil, and char are formed.

### CLAIM OF PRIORITY

This application claims priority to U.S. Provisional Patent Application No. 60/953,341, filed Aug. 1, 2007, the disclosure of which is hereby incorporated by reference herein.

### FIELD OF THE INVENTION

The present invention relates to processes for thermochemical conversion of poultry litter into useable products. The present invention allows for waste poultry litter to be converted into fuels and other products, such as fertilizers.

### BACKGROUND OF THE INVENTION

The disposal of poultry litter has become a major problem for the poultry industry in the US because of environmental concerns. The traditional method of land application is now limited because of non-availability of land and composting as a disposal alternative is also limited. Combustion technology for power and heat generation using poultry litter is still under development, but may not be suitable for small scale growers and EPA non-attainment areas, because these are usually very large scale operations requiring thousands of tons of poultry litter per day to be profitable. Thus, there is a need to develop novel technologies to address these waste disposal problems, especially for small scale growers and other growers in EPA non-attainment areas.

The US is the world's largest producer and exporter of poultry meat and the second largest egg producer. The total farm value of poultry production was $22.4 billion in 1999. The poultry industry generates several types of wastes but the three wastes of primary concern to growers are bedding litter used for poultry housing, manure from poultry production, and dead birds common to all operations. In general, poultry litter consists of a mixture of bedding, manure, feathers, and spilled feed. In the US 5.6 million tons of litter dry matter is produced per year. The litter must be disposed to ensure a safe and healthy environment for the birds and the poultry workers. The major disposal methods include land application as fertilizer or soil conditioner; feeding to animals as protein supplement; and composting of litter and mortality.

Land application is the most important method used to date. When used as fertilizer, poultry manure can provide valuable organic material and nutrient for crop and pasture growth. However, these same nutrients can degrade water quality if they are over-applied to the land and enter water resources through runoff and leaching. The Clean Water Act regulations require the largest poultry producers to meet nutrient applications standards when applying manure to the land. The levels of phosphorus, nitrogen, and potassium can become excessive after several applications and runoffs and leaching can lead to pollution of water resources and eutrophication of lakes and rivers.

Poultry litter contains 25-50% crude proteins, calcium, potassium, phosphorus, and essential minerals which have been used as animal feed supplement. Adding 20% or higher litter to beef cows and stocker cattle rations has been found to be beneficial and a cheap source of crude proteins for the animals. However, recent concerns about bovine spongiform encephalopathy (BSE) have cast doubt on the continued use of this material as a suitable feed supplement.

Composting of poultry litter and mortality as an alternative disposal method has also been practiced. Composting takes 4-6 weeks to reach stabilized material. The composted material is odorless and fine textured which can be used as fertilizer. The major disadvantages of composting are loss of nitrogen and other nutrients during composting, equipment and labor cost, odor, and available land.

Another important method for poultry litter disposal is direct combustion which could potentially provide energy for space heating of poultry houses and large scale applications for power generation. However, these systems require very efficient pollution abatement equipment to meet air pollution standards. Thus, poultry litter combustion is not widely practiced. Poultry litter has a low calorific value (10.62 MJ/kg) which decreases with increasing moisture content. The ash content is high (15 to 20%) and it has low fusion temperature which can cause fouling and slagging in conventional grate combustion systems. Although some poultry litter combustion plants have been operated in the United Kingdom (UK) with capacities ranging from 13.5 MW to 38.5 MW, there are no such facilities operating in the US. Proposals have been made to develop chicken litter combustion systems in the US, but only test burns have been carried at the Maryland Eastern Correctional Institute. The major concern about the operation of poultry litter electric power generation facility is air pollution.

The power plants that are operational in the UK are large and require large volumes of litter to be profitable. For small poultry farms where the excess poultry litter is about 100 to 150 tons per annum, power generation facilities may not be economically feasible. Such facilities will require transportation of waste material from other regions to the processing plant. Such operations may increase the operation cost and therefore may not be economically feasible.

Other technologies such as gasification and pyrolysis have not been thoroughly investigated and no such commercial systems are operational in either Europe or the US. Pyrolysis may be suitable for small farms because a central or modular pyrolysis plant could produce liquid fuel from the poultry litter which could then be distributed to the various farms for on-farm heating of poultry houses. In addition, the pyrolysis chars which will normally trap most of the inorganic residue that could be used as a slow-release fertilizer. Furthermore, because the pyrolysis temperatures are normally between 400-600° C., this will not pose any ash fusion and slagging problems. As such, there is a need in the art for a pyrolysis technology alternative method for waste disposal that also generates higher-value products (energy and fertilizer) for on-farm applications.

### SUMMARY OF THE INVENTION

It is an object of the present invention to provide processes for the conversion of waste litter into useful products, such as fuels and fertilizers. The processes of the present invention involve pyrolysis of waste litter using a fluid bed pyrolysis system. The waste litter is entrained in a fluid that carries it to a fluidized medium heated to a temperature suitable for pyrolysis. As the waste litter is entrained into the fluidized medium, it is pyrolyzed, and the pyrolysis products are carried out of the reactor, where they are collected.

It is a further object of the present invention to provide biooil produced from pyrolysis of waste litter. The biooil produced from the waste litter has use as a fuel or chemical feedstock. The properties of the biooil may be adjusted by adding certain additives to the waste litter before pyrolysis. Additives include Amosoak, a proprietary litter amending agent, and wood shavings.

### DETAILED DESCRIPTION OF THE DRAWINGS

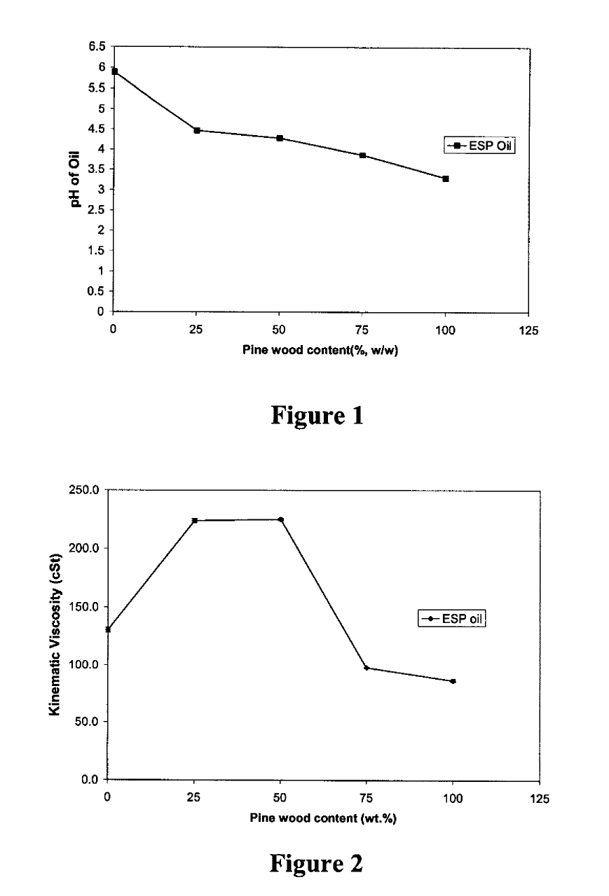

FIG. 1 shows a plot of the influence of pine wood shavings on the pH of poultry manure/pine wood shavings mixture biooils.

FIG. 2 shows a plot of the influence of pine wood shavings on the viscosity of poultry manure/pine wood shavings mixture biooils.

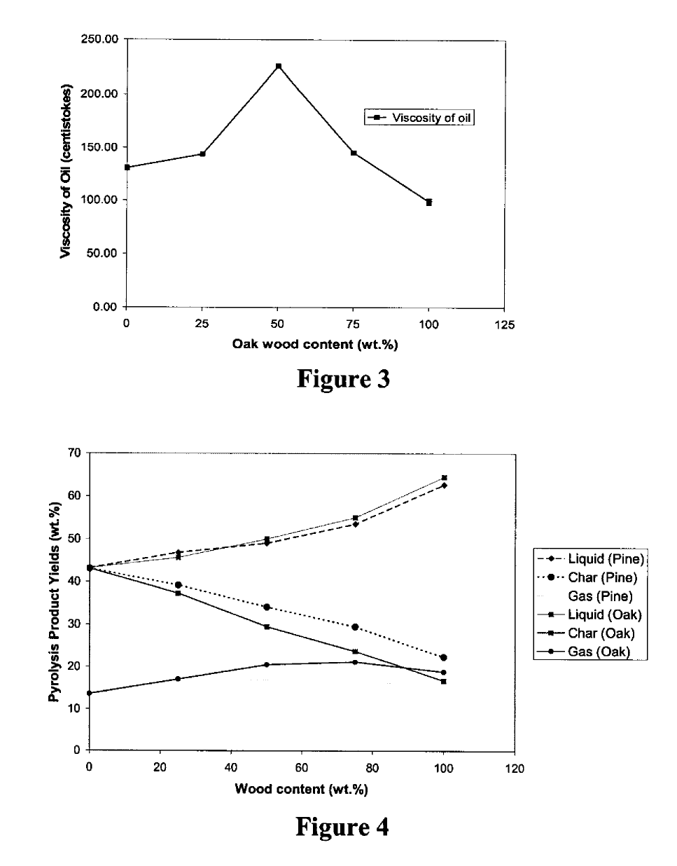

FIG. 3 shows a plot of the influence of oak wood shavings on the pH of poultry manure/oak wood shavings mixture biooils.

FIG. 4 shows a plot of the influence of wood shavings on the yield of biooil, biochar, and gases from poultry manure/wood shavings mixture.

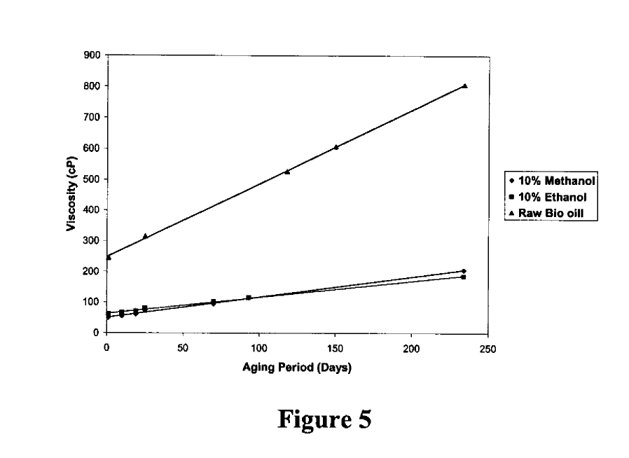

FIG. 5 shows a plot of the influence of alcohol additives on the viscosity changes of biooils from poultry manure/wood shavings mixtures.

### DETAILED DESCRIPTION OF THE INVENTION

The present invention provides processes for the thermochemical conversion of litter, such as poultry litter, into useful products such as oils, fuels and fertilizers. The thermochemical process of the present invention involves pyrolysis of litter using a fluidized bed.

The processes of the present invention involve the use of a suitable fluidized medium in a fluidized bed pyrolysis system. In typical embodiments of the present invention, the reactor used for performing the pyrolysis is a fluidized bed reactor as is well known in the art. Examples of fluidized bed reactors can be found in Howard, J. R. (1989). “Fluidized Bed Technology: Principles and Applications.” New York, N.Y.: Adam Higler; Tavoulareas, S. (1991.) Fluidized-Bed Combustion Technology. **Annual Reviews Inc.** 16, 25-27; and Trambouze, P., & Euzen, J. (2004). “Chemical Reactors: From Design to Operation.” (R. Bononno, Trans.). Paris: Editions Technip, which are all hereby incorporated by reference.

The litter to be pyrolyzed is typically ground to a small particle size in order to effect rapid pyrolysis. The litter may be ground in a mill until the desired particle size is achieved. Typically, the particle size of the biomass to be pyrolyzed is a particle size sufficient to pass through a 1-mm screen up to a particle size sufficient to pass through a 30-mm screen.

The litter to be pyrolyzed may be standard litter produced by any type of poultry keeping operation. Poultry litter typically consists of a mixture of bedding, manure, feathers, and spilled feed, however, it need not have all of these components and may also consist of other components. It is also contemplated that other types of bird litter could be used in the methods of the present invention.

It is also contemplated that additives can be introduced into the poultry litter before it is pyrolyzed. These additives may be useful in improving the properties of the resultant pyrolysis products.

In certain embodiments of the invention, the litter is treated with varying amounts of Amosoak. Amosoak is a proprietary compound comprising steam treated agricultural residue of acidic pH in water and is described above in detail in International Patent Application WO2008/024730 to Agblevor, et al., which is hereby incorporated by reference. Not only does Amosoak reduce the odor of the litter, it has been unexpectedly found that the addition of Amosoak can increase biooil yields as well as cause the biooil to have improved pH values. The amount of Amosoak incorporated into litter may be from about 0.1% to about 40% by weight of the dry litter, more preferably from about 1% to about 20% by weight of the dry litter. Thus, Amosoak may be used to control the pH of the biooil. The pH of the untreated biooil ranged in many cases ranged from 6 to 8, but with the addition of Amosoak, the pH range of the oil can reduced to as low as 4 depending on the amount of Amosoak added to the litter before the pyrolysis. A non-limiting example of the effects of the addition of Amosoak to litter can be found in the Examples below.

In other embodiments, wood shavings may be added to the poultry litter before pyrolysis. The addition of wood shavings helps control the pH and yield of the biooil. In certain embodiments, wood shavings concentrations of about 25% to about 75% by weight were incorporated into the poultry litter, with an incorporation of about 50% by weight preferred. It has been shown that as the wood shavings content increases, the biooil yield increases and its pH decreases. Further, the viscosity of the biooil and its density were also strongly affected by the amount of wood shavings added. Up to about 50% by weight the addition of wood shavings increased the viscosity of the oil, but above 50%, the oil viscosity started to decrease. As such, wood shavings can be added to the litter to control the yield, pH and viscosity of the biooil product as desired. A non-limiting example of the effects of the addition of Amosoak to litter can be found in the Examples below.

The litter to be pyrolyzed is loaded into an entrainment compartment to be carried into the fluidized bed by the fluid. The litter may be loaded into a feed hopper or other device which allows for it to be delivered to the entrainment compartment in a suitable amount. In this manner, a constant amount of litter is delivered into the entrainment compartment.

Once the litter enters the entrainment compartment, it is carried by the fluid to the reactor bed. In certain embodiments of the present invention, the fluid used is nitrogen gas. However, it is also contemplated that other non-oxidizing fluids could be used in the processes of the present invention. It is further contemplated that the pyrolysis gas produced during the processes can be recycled and used as the entrainment fluid. In this manner, the costs of performing the pyrolysis can be greatly reduced.

The fluid carries the litter from the entrainment compartment to the fluidized bed through a feeder tube. Typically, the feeder tube is cooled in some manner to maintain the temperature of the litter before it enters the fluidized bed. The feeder tube may be cooled by jacketing the tube, typically with an air-cooled or liquid-cooled jacket. However, it is also contemplated that the feed tube not be cooled.

The fluidized bed of the reactor comprises a medium suitable to retain and transfer the heat necessary for pyrolyzing the litter. In certain embodiments of the invention, the fluidized medium is sand. However, it is also contemplated that other media which are capable of being heated to temperatures suitable for pyrolysis and are capable of being fluidized can be used as the fluidized medium.

Depending on the desired reaction products, the temperature of the fluidized bed may be adjusted. In certain embodiments, the temperature of the fluidized bed may be between about 400° C. and about 650° C., more preferably between about 450° C. and 600° C., and most preferably about 500° C. The flow rate of the fluid is set so that the apparent pyrolysis vapor residence time is about 5 seconds, however, other longer or shorter vapor residence times, such as about 0.5 to about 10 seconds, may also be used with the processes of the present invention. Gas flow and other parameters, such as temperature and pressure, may be monitored from a single data acquisition unit, such as an Omega data acquisition unit from Omega Engineering, Inc. of Stamford, Conn.

The litter may be fed into the reactor for as long as is necessary to process the desired amount of litter into pyrolysis product. A pyrolysis run may be as short as minutes and may be as long as several hours as needed. The rate at which biomass feedstock may be fed into the reactor may be varied, with typical feed rates of about 50 to about 150 g/h being used and a feed rate of about 100 g/h being preferable.

The temperature of different parts of the reactor may be measured and regulated using temperature devices known in the art such as thermocouples. If such devices are used, they may be linked to the data acquisition unit. Typically, measurements may be taken and the temperature regulated in the fluidized bed, directly above the bed, and at the exit of the reactor. The fluidized bed temperature may be measured and maintained as described above. It is desirable to have the temperature above the bed and at the exit zone of the reactor to be set at a lower temperature than the catalysts to avoid cracking of the pyrolysis products. The temperature of the area above the bed and the exit zone may be the same or different, and may be between about 10° and about 100° C. less than the temperature of the fluidized bed, with a preferred temperature difference of about 50° C.

The gases and vapors exiting the reactor may be passed through a filter to remove and solids entrained in the exiting fluid. If filters are used, it is preferred that they be hot gas filters to prevent condensation of the pyrolysis vapors. When used, the hot gas filters may be kept at a suitable temperature to prevent condensation, for example between about 300° to about 500° C. The reactor may have pressure gauges that measure the pressure at various points in the fluid stream. If a hot gas filter is used, it provides the additional advantage of removing char from the biooil product, causing the biooil product to be more stable. Total gas flow through the system may be determined by a rotameter. Feedback from these instruments may also be transmitted to the data control system.

After the pyrolysis vapors exit the reactor, they are passed through a condensation train to collect the desired products in vapor and gas form. Typically, the condensation train will comprise one or more chilled water condenser, one or more electrostatic precipitator, and one or more coalescent filter, all of which are well known in the art, all of which will be connected in series. The sequence of the condensers may be varied, however, it is typically that the first condenser is a chilled water condenser. When used, the electrostatic precipitator may be kept at a voltage of about 15 to about 25 kV, more preferably between about 18 to about 20 kV. The voltage of the electrostatic precipitator may also be regulated by the data acquisition unit. All gasses that pass through the condensation train may also be collected at the end of the train. Pyrolysis products such as char may also be separated using a high efficiency cyclone and/or a hot gas filter. These products are collected in the cyclone or on the filter where they can be later isolated.

Various pyrolysis products can be collected, including producer gas, bio-oil and char (slow—release fertilizer or black manure). After pyrolysis using the methods of the present invention, these pyrolysis products are immediately useable in other applications, and do not typically require other processing steps. Other pyrolysis products may also be obtained using the processes of the present invention and it should be apparent that the types and amounts of products obtained will depend on the composition of the litter that is pyrolyzed.

Methods for improving the properties of the biooil through additives to the poultry litter are described above. It has also been found that the stability of the biooil can be enhanced by adding a solvent to the biooil for storage. In certain embodiments, the solvent added to the biooil is ethanol, methanol, acetone, or water. When added, the solvents may be added at a concentration of about 1% to about 10% by weight of the oil, with a preferred concentration of 10% by weight of the oil. When a solvent is added, the biooil may be stored up to six months or longer without any signifcant increase in the viscosity of the biooil.

Pyrolysis products may be analyzed using techniques well known in the art, such as gas chromatography/mass spectrometry (GC/MS), gel permeation chromatography (GPC), and nuclear magnetic resonance (NMR). Non-limiting examples of analysis of pyrolysis products are shown in the examples below.

Non-limiting examples of processes for pyrolyzing litter are given below. It should be apparent to one of skill in the art that there are variations not specifically set forth herein that would fall within the scope and spirit of the invention as claimed below.

### EXAMPLES

### Example 1

### Pyrolysis of Poultry Litter

A thermochemical conversion method has been developed that converts poultry litter into at least three products: producer gas, bio-oil and char (slow—release fertilizer or black manure). The black manure (slow-release fertilizer) yield was 40 wt % of the starting feedstock and contained all the essential minerals (phosphorous, potassium, calcium, sodium, and a fraction of nitrogen) in the raw poultry litter. The rate of release of potassium from the “black manure” was three times less than that in the raw poultry litter and the rate of phosphorus and calcium release was ten times less than that from the raw poultry litter.

The pyrolysis studies were conducted in a two-inch (50 mm) bubbling fluidized bed reactor located at the Department of Biological Systems Engineering at Virginia Tech in Blacksburg, Va. The reactor consists of a 2-in. (50 mm) schedule 40 stainless steel pipe, 20 in. (500 mm) high (including a 5.5 in. (140-mm) preheater zone below the gas distribution plate) and equipped with a 100-μm porous metal gas distributor. The fluidizing medium was sand and the bed was fluidized with nitrogen. The reactor tube, which contains a bubbling fluid bed with back-mixing of the feed is externally heated with a three-zone electric furnace.

The ground poultry litter (−20 mesh) was loaded into a feed hopper (batch-wise) and conveyed by a twin-screw feeder into an entrainment compartment where high-velocity nitrogen gas was used to entrain the feed and carry it through a jacketed air-cooled feeder tube into the fluidized bed. Wood chip controls were also treated in the same manner. The composition of the starting materials is shown in Table 1. The pyrolysis temperature was maintained at 400-500° C. and the apparent pyrolysis vapor residence time was varied from 0.5 to 5 seconds. The experiments lasted for 2-3 h and the feed rate was 100 g/h. The feed rate, gas flow rate, and reactor temperature were kept constant during each run. The sand bed and reactor temperatures were measured and controlled by three K-thermocouples inserted into a thermal well in the reactor.

TABLE 1
Characteristics of Litter Samples

| | Moisture | | Nitrogen | |
|---|---|---|---|---|
| Samples | (%)^{[a]} | Ash (%)^{[b]} | Analysis (%) | HHV (MJ/kg) |
| Wood Chips | 8.08 | 0.43 | <0.5 | 19.54 |
| Flock 1 - litter | 22.81 | 22.80 | 3.13 | 15.14 |
| Flock 2 - litter | 31.49 | 22.60 | 3.51 | 16.28 |
| Broiler litter | 33.35 | 21.45 | 3.45 | 15.76 |
| Turkey litter | 16.25 | 5.93 | 1.12 | 18.74 |

^{[a]}ASTM E1756-01, Standard Test Method for Determination of Total Solid in Biomass
^{[b]}ASTM E1755-01, Standard Test Method for Ash in Biomass

The pyrolysis vapors exiting the reactor were condensed in a series of water-cooled condensers and an electrostatic precipitation unit. The char fraction was separated in a high efficiency cyclone and a hot gas filter unit. The total volume of the gaseous products was measured using a totalizer and the composition determined by gas chromatography.

The pyrolysis oil (pyrodiesel or biooil) was analyzed for ultimate composition, calorific value, pH, moisture, and char content. The pyrodiesel, gas, and char yields were determined as well as the overall conversion of the poultry litter. The product yields are shown in Table 2.

TABLE 2
Product Yields From Fluidized Bed Pyrolysis

| | Temperature | Yield, wt % | | |
|---|---|---|---|---|
| Sample | ° C. | Oil | Gas | Char |
| wood chips | 450 | 41.8 | 9.9 | 48.3 |
| [chicken | 500 | 42.3 | 25.7 | 32.0 |
| bedding] | 550 | 34.6 | 17.1 | 48.3 |
| Flock 1 - litter | 450 | 23.5 | 35.9 | 40.6 |
| | 500 | 23.0 | 36.9 | 40.1 |
| | 550 | 27.0 | 33.0 | 40.0 |
| Flock 2 - litter | 450 | 23.1 | 32.2 | 44.7 |
| | 500 | 21.6 | 39.1 | 39.3 |
| | 550 | 20.7 | 42.3 | 37.0 |
| Broiler Litter | 450 | 19.2 | 46.6 | 34.2 |
| | 500 | 23.4 | 42.8 | 33.8 |
| | 550 | 14.7 | 51.4 | 33.9 |
| Turkey litter | 450 | 29.1 | 36.9 | 34.0 |
| | 500 | 26.3 | 49.2 | 24.5 |
| | 550 | 16.3 | 61.3 | 22.4 |

The char fraction and biooil fraction was analyzed for elemental composition and elemental balance. The ash contents of the biooils and char are shown in Table 3. The characteristics of the biooils formed in the 500° C. pyrolysis runs is shown in Table 4. The composition of the char samples is shown in Table 5 while the ash composition of the litter samples is shown in Table 7. The samples were leached with water to determine the rate of release of various elements trapped in the char. The results of the leaching are shown in Table 7. The rate of release of potassium, phosphorus, calcium and nitrogen were considered very important.

TABLE 3
Ash Content of Biooils and Char

| | | Ash Contents, wt % | |
|---|---|---|---|
| Sample | Temperature ° C. | Oil | Char |
| wood chips [chicken | 450 | 0.38 | 1.40 |
| bedding] | 500 | 0.10 | 3.13 |
| | 550 | 0.05 | — |
| Flock 1 - litter | 450 | 0.55 | 55.69 |
| | 500 | 1.37 | 61.61 |
| | 550 | 0.86 | 66.26 |
| Flock 2 - litter | 450 | 1.32 | 53.89 |
| | 500 | 0.48 | 58.27 |
| | 550 | 2.01 | 57.15 |
| Broiler Litter | 450 | 0.97 | 42.48 |
| | 500 | 1.83 | 45.93 |
| | 550 | 1.31 | 46.99 |
| Turkey litter | 450 | 0.59 | 35.69 |
| | 500 | 0.71 | 25.48 |
| | 550 | 1.02 | 21.55 |

TABLE 4
Characteristics of Biooils, 500° C.

| | C | H₂ | O | N₂ | | HHV |
|---|---|---|---|---|---|---|
| Samples | (%) | (%) | (%) | (%) | Ash (%)^{[a]} | (MJ/kg) |
| Wood Chips | 45.22 | 7.70 | 48.73 | <0.5 | 0.10 | 18.11 |
| Flock 1 - litter | 58.07 | 7.22 | 22.77 | 8.30 | 1.38 | 27.49 |
| Flock 2 - litter | 62.58 | 9.01 | 26.61 | 6.93 | 0.48 | 29.49 |
| Broiler Litter | 61.16 | 7.90 | 22.10 | 8.43 | 1.83 | 27.98 |
| Broiler Litter (HF) | 57.06 | 7.96 | 20.58 | 8.12 | 0.1 | 25.35 |
| Turkey litter | 60.62 | 7.16 | 28.68 | 4.21 | 0.71 | 26.24 |

^{[a]}ASTM E1755-01, Standard Test Method for Ash in Biomass

TABLE 5
Composition of Char Samples

| | Temp | | | | |
|---|---|---|---|---|---|
| Sample | (° C.) | Ca (ppm) | K (ppm) | P (ppm) | N (ppm) |
| Chicken bedding | 500 | 132 | 71 | 6 | |
| Flock 1 - litter | 500 | 2,409 | 1,756 | 1,020 | |
| Flock 2 - litter | 500 | 2,850 | 2,734 | 1,168 | |
| Turkey litter | 500 | 1,370 | 1,415 | 860 | |
| Broiler Litter | 500 | 2,902 | 2.983 | 1,457 | 2320 |

TABLE 6
Ash Composition of Litter Samples

| Sample | Ca (ppm) | K (ppm) | P (ppm) |
|---|---|---|---|
| Chicken bedding | 125 | 106 | 8 |
| Flock 1 - litter | 1,738 | 1,453 | 915 |
| Flock 2 - litter | 1,627 | 1,488 | 896 |
| Turkey litter | 1,743 | 1,574 | 1,069 |
| Broiler Litter | 1,415 | 2,125 | 1,003 |

TABLE 7
One Hour Leaching of Broiler Litter Samples

| | Element | | | | |
|---|---|---|---|---|---|
| | Ca | K | P | H₂O | HCl |
| Original (ppm) | 57 | 1261 | 114 | yes | no |
| Batch char (ppm) | 6 | 403 | 6 | yes | no |
| Column char | 4 | 453 | 9 | yes | no |
| (ppm) | | | | | |
| Char residue | 1735 | 888 | 982 | no | yes |
| (ppm) | | | | | |

### Example 2

### Control of Odor in Poultry Litter Before Pyrolysis

In order to make the pyrolysis of poultry litter more worker and environmentally-friendly, a litter amendment procedure was developed such that when the litter is treated with varying amounts of Amosoak, this reduces the odor from the litter. Amosoak is a proprietary compound comprising steam treated agricultural residue of acidic pH in water and is described above. The amount of Amosoak incorporated into litter was from 1 wt % to 20 wt % of the dry litter. The addition of Amosoak to the litter bad two positive effects: the yield of biooil from the litter increased from 40 to 50% and the amount of gas produced decreased. The Amosoak also influenced the acidity of the biooil. Thus, a technique has been developed to control the pH of the biooil. The pH of the untreated biooil ranged from 6 to 8, but with the addition of Amosoak, the pH range of the oil can reduced to as low as 4 depending on the amount of Amosoak added to the litter before the pyrolysis.

### Example 3

### Control of pH and Increase in Oil Yield

We also demonstrated that the pH and yield of the biooil can be controlled by incorporation of various concentrations of fresh wood shavings into the poultry litter. Wood shavings concentrations of 25 wt % to 75 wt % were incorporated into the poultry litter. FIGS. 1, 2, 3, and 4 show the influence of the wood shavings on the biooil properties and the yield of biooils. Table 8 shows the pyrolysis yields. Table 9 shows the physiochemical properties of oils produced at various concentrations of pine wood shavings. As the wood shavings content increased, the biooil yield increased and its pH decreased. The viscosity of the biooil and its density were also strongly affected by the amount of wood shavings added. Up to 50 wt % addition of wood shavings increased the viscosity of the oil, but above 50%, the oil viscosity started to decrease. Table 10 shows the properties of the pyrolysis products made from starting materials having varying concentrations of oak wood shavings. Table 11 shows the composition of a standard broiler char sample. Thus, one can produce biooils with specific viscosities as may be required for any specific process.

TABLE 8
Pyrolysis product yields of poultry litter and chicken bedding samples.

| | Reactor | Products yield (wt %) | | |
|---|---|---|---|---|
| Sample | temp (° C.) | Oil | Char | Gas |
| Flock-1 litter | 500 | 45.7 ± 2.9 | 40.6 ± 6.2 | 13.6 ± 5.7 |
| Flock-2 litter | 500 | 36.8 ± 1.2 | 40.8 ± 1.9 | 22.3 ± 2.5 |
| Flock-3 litter | 500 | 43.5 ± 5.1 | 32.9 ± 3.7 | 23.6 ± 6.4 |
| Starter Turkey litter | 500 | 50.2 ± 1.6 | 27.6 ± 1.7 | 21.7 ± 1.9 |
| Chicken bedding | 500 | 63.3 ± 11.3 | 12.7± | n/a |

TABLE 9
Summary of physioco-hemical properties of manure and pine wood oils

| | | Pyrolysis Oils (ESP) | | | | |
|---|---|---|---|---|---|---|
| | | | M:P | M:P | M:P | 100% |
| Physical property | Analysis Method | 100% M | (25/75) | (50/50) | (25/75) | P |
| Moisture content (wt. %) | Karl-Fischer | 6.46 | 6.14 | 4.13 | 3.14 | 3.65 |
| | titration | | | | | |
| Water content of whole | Karl-Fischer | 41.38 | 37.61 | 38.13 | 33.93 | 25.84 |
| oil (wt. %) | titration | | | | | |
| pH | pH meter | 5.93 | 4.47 | 4.29 | 3.87 | 3.04 |
| Density @ 23° C., g/m³ | ASTM D4052 | 1.14 | 1.20 | 1.21 | 1.24 | 1.26 |
| Kinematic viscosity, at | Rotational | 130.0 | 223 | 225 | 97 | 86 |
| 60° C. (cSt) | Viscometer | | | | | |
| Ash Content, wt. % | ASTM D482 | <0.08 | <0.07 | <0.06 | <0.05 | <0.08 |
| Heating Value (MJ/kg) | ASTM D5865 | 27.90 | 27.22 | 26.63 | 25.45 | 24.77 |
| Elemental Composition | ASTM D3176 | | | | | |
| (%) | Mod. | | | | | |
| C | | 61.86 | 60.93 | 61.08 | 60.80 | 58.29 |
| H | | 8.02 | 7.56 | 7.11 | 6.86 | 6.71 |
| N | | 5.88 | 4.18 | 2.90 | 1.36 | <0.5 |
| O* | | 23.93 | 27.10 | 28.75 | 30.75 | 34.99 |
| S | | 0.28 | 0.21 | 0.15 | 0.081 | <0.05 |
| Cl | | 318 ppm | 193 ppm | 149 ppm | 118 ppm | 137 ppm |
| H/C molar ratio | | 1.56 | 1.49 | 1.40 | 1.35 | 1.38 |
| O/C molar ratio | | 0.29 | 0.33 | 0.35 | 0.38 | 0.45 |
| N/C molar ratio | | 0.08 | 0.06 | 0.04 | 0.02 | 0.01 |

TABLE 10
Summary of Pyrolysis Results With Oak Wood Shavings

| Feedstock | | | Pyrolytic Yields (%) | | |
|---|---|---|---|---|---|
| Manure | Oak wood | Mean Reactor | Total | | |
| (wt. %) | (wt. %) | Temperature (° C.) | liquid | Char | ^{†}Gas |
| 100.0 | 0.0 | 468.8 | 43.25 ± 0.43 | 43.1 ± 0.95 | 13.6 ± 1.00 |
| 75.0 | 25.0 | 461.6 | 45.68 ± 1.05 | 37.29 ± 0.30 | 17.04 ± 1.39 |
| 50.0 | 50.0 | 448.4 | 50.03 ± 2.33 | 29.48 ± 0.73 | 20.44 ± 2.19 |
| 25.0 | 75.0 | 433.5 | 55.05 ± 2.29 | 23.78 ± 1.01 | 21.8 ± 2.44 |
| 0.0 | 100.0 | 420.5 | 64.50 ± 0.30 | 16.72 ± 2.65 | 18.78 ± 2.36 |

TABLE 11
Composition of broiler biochar

| Compound/element | Composition |
|---|---|
| Total N, % | 2.84 |
| P₂O₅, % | 2.68 |
| K₂O, % | 4.19 |
| Ca, % | 7.5 |
| Mg, % | 1.54 |
| S, % | 0.99 |
| Al, % | 0.54 |
| B, % | 0.01 |
| Cu, % | 0.11 |
| Fe, % | 0.54 |
| Mn, % | 0.12 |
| Na, % | 2.05 |
| Zn, % | 0.1 |
| Cd, mg/kg | 1.0 |
| Ni, mg/kg | 40.0 |
| Se, mg/kg | 1.9 |
| Mo, mg/kg | 16.0 |
| Co mg/kg | 5.0 |

### Example 4

### Stabilization of Biooil with Water and Low Molecular Weight Organic Solvents

The viscosity of the biooils increased very rapidly when they were stored under ambient laboratory conditions. However, the addition of any of the following solvents 10 wt % ethanol, 10 wt % methanol, 10 wt % acetone, and 10 wt % water stabilized the biooil and it could be stored up to six months without increase in the viscosity of the biooil (see FIG. 5). Interestingly, when the oils were tightly covered with minimal loss of water, the viscosity increases were also considerably reduced. Thus, increase in the viscosity of the biooil was caused by both evaporation of the low molecular weight fractions of the biooil as well as chemical reaction of the biooil fractions. Ethanol, methanol, and acetone reduced the increase in the viscosity of the oil because they blocked any esterification reactions between the biooil components. It appears the presence of water in the oil also increased the storage stability of the oil probably because the excess water in the biooil caused the reverse esterification reaction to be dominant and therefore lowering the rate of formation of high molecular weight material that contributes to the increase in viscosity of the biooil oil. Thus, the presence of water, ethanol, methanol, and acetone stabilizes the biooil.

### Example 5

### Stability of Oil Using a Hot Gas Filter

The char content of the biooil was considerably reduced by the use of a ceramic hot gas filter. The char/ash content of the oils were less than 0.5 wt % and this improved the stability of the oil because some viscosity reactions are also catalyzed by biochar entrained in the oil.

### Example 6

### Slow Release Fertilizer

Several leaching studies were conducted on the biochar using distilled water and also testing them in pots. The results showed that the release of various nutrients from the char was much less than that from the untreated poultry litter. However, the nitrogen content of the biohar was reduced to 30%. To increase the nitrogen content of the biochar, a small fraction of the biooil was used as a binder because the biooil has twice the nitrogen content of the biochar.

What is claimed is:

1. A process for converting waste litter into a product slate, the process comprising:
a) providing a reaction vessel comprising:
a reactor bed comprising a fluidizing medium fluidized by a non-reactive gas, the reactor bed being maintained at a temperature sufficient for pyrolysis of the waste litter; and
an entraining flow of the non-reactive gas which flows into the reactor bed;
b) causing waste litter to be entrained into the flow of non-reactive gas, so that the waste litter is delivered to the reactor bed and pyrolyzed; and
c) collecting the resultant product slate.

2. The process for converting waste litter of claim 1, wherein the waste litter is poultry litter.

3. The process for converting waste litter of claim 1, wherein the fluidizing medium is sand.

4. The process for converting waste litter of claim 1, wherein the non-reactive gas is nitrogen.

5. The process for converting waste litter of claim 1, wherein the non-reactive gas is pyrolysis gas.

6. The process for converting waste litter of claim 1, wherein the resultant product slate comprises components selected from the group consisting of: producer gas, biooil, char, and mixtures thereof.

7. The process for converting waste litter of claim 1, wherein the temperature sufficient for pyrolysis of the waste litter is between about 400° C. and about 650° C.

8. The process for converting waste litter of claim 7, wherein the temperature sufficient for pyrolysis of the waste litter is between about 450° C. and 600° C.

9. The process for converting waste litter of claim 8, wherein the temperature sufficient for pyrolysis of the waste litter is about 500° C.

10. The process for converting waste litter of claim 1, wherein Amosoak is added to the litter before pyrolysis.

11. The process for converting waste litter of claim 10, wherein the Amosoak is added at a concentration of about 0.1% to about 40% by weight of the litter.

12. The process for converting waste litter of claim 11, wherein the Amosoak is added at a concentration of about 1% to about 20% by weight of the litter.

13. The process of converting waste litter of claim 1, wherein wood shavings are added to the litter before pyrolysis.

14. The process for converting waste litter of claim 13, wherein the wood shavings are added at a concentration of about 25% to about 75% by weight of the litter.

15. The process for converting waste litter of claim 14, wherein, wherein the wood shavings are added at a concentration of about 50% by weight of the litter.

16. A biooil composition made by a process comprising:
a) providing waste litter;
b) providing a reaction vessel comprising:
a reactor bed comprising a fluidizing medium fluidized by a non-reactive gas, the reactor bed being maintained at a temperature sufficient for pyrolysis of the waste litter; and
an entraining flow of the non-reactive gas which flows into the reactor bed;
c) causing waste litter to be entrained into the flow of non-reactive gas, so that the waste litter is delivered to the reactor bed and pyrolyzed; and
d) collecting the resultant biooil composition.

17. The biooil of claim 16, wherein Amosoak is added to the litter before pyrolysis.

18. The biooil of claim 17, wherein the Amosoak is added at a concentration of about 0.1% to about 40% by weight of the litter.

19. The biooil of claim 18, wherein the Amosoak is added at a concentration of about 1% to about 20% by weight of the litter.

20. The biooil of claim 16, wherein wood shavings are added to the litter before pyrolysis.

21. The biooil of claim 20, wherein the wood shavings are added at a concentration of about 25% to about 75% by weight of the litter.

22. The biooil of claim 21, wherein the wood shavings are added at a concentration of about 50% by weight of the litter.

23. The biooil composition of claim 16, further comprising a solvent selected from the group consisting of: ethanol, methanol, acetone, or water.

24. The biooil composition of claim 23, wherein the solvent is present at a concentration of between about 1% and about 20% by weight of the biooil.

25. The bioloil composition of claim 24, wherein the solvent is present at a concentration of about 10% by weight of the biooil.
